(19) United States
(12) Patent Application Publication
(10) Pub. No.: US 2025/0023108 A1
(43) Pub. Date: Jan. 16, 2025

(54) MANUFACTURING METHOD FOR NONAQUEOUS ELECTROLYTE SECONDARY BATTERY

(71) Applicant: Prime Planet Energy & Solutions, Inc., Tokyo (JP)

(72) Inventors: Yohei SHINDO, Toyota-shi (JP); Atsushi MATSUSHIMA, Toyota-shi (JP)

(21) Appl. No.: 18/757,504

(22) Filed: Jun. 28, 2024

(30) Foreign Application Priority Data
Jul. 7, 2023 (JP) 2023-111836
Mar. 11, 2024 (JP) 2024-037448

(51) Int. Cl. H01M 10/0587; H01M 4/02; H01M 4/36; H01M 4/505; H01M 4/525; H01M 10/0525; H01M 10/0566; H01M 10/44

(52) U.S. Cl. CPC H01M 10/0587; H01M 4/366; H01M 4/505; H01M 4/525; H01M 10/0525; H01M 10/0566; H01M 10/446; H01M 2004/028

(57) ABSTRACT

A method for manufacturing a nonaqueous electrolyte secondary battery disclosed herein includes the steps of: preparing a battery assembly including a positive electrode, a negative electrode, and a nonaqueous electrolyte; performing initial charging on the battery assembly; and performing an aging process on the battery assembly having been subjected to the initial charging. The positive electrode includes a positive electrode active material layer containing a positive electrode active material and a thiophosphoric acid salt. A content of the thiophosphoric acid salt in the positive electrode active material layer is 1 mass % to 10 mass %. The initial charging is performed up to a voltage more than or equal to a decomposition start potential of the thiophosphoric acid salt. The aging process is performed in a state where the battery assembly is charged to the voltage more than or equal to the decomposition start potential of the thiophosphoric acid salt.

### BACKGROUND OF THE DISCLOSURE

### 1. Field

The present disclosure relates to a manufacturing method for a nonaqueous electrolyte secondary battery. This application claims the benefit of priority to Japanese Patent Application No. 2023-111836 filed on Jul. 7, 2023 and Japanese Patent Application No. 2024-037448 filed on Mar. 11, 2024, the entire contents of which are incorporated herein by reference.

### 2. Background

In recent years, a nonaqueous electrolyte secondary battery such as a lithium ion secondary battery has been used suitably for a portable power source for a personal computer, a mobile terminal, or the like, a power source for driving a vehicle such as a battery electric vehicle (BEV), a hybrid electric vehicle (HEV), or a plug-in hybrid electric vehicle (PHEV), or the like.

A positive electrode of the nonaqueous electrolyte secondary battery typically includes a positive electrode active material layer containing a positive electrode active material. In one of the known techniques for improving the performance of the nonaqueous electrolyte secondary battery, the positive electrode active material layer contains an additive (so-called positive electrode additive) for forming a film on a surface of the positive electrode active material. For example, according to Japanese Patent Application Publication No. 2002-352804, the cycle characteristic of a nonaqueous electrolyte secondary battery is improved when a positive electrode active material layer contains thiophosphoric acid ester or a thiophosphoric acid ester salt. In another example, according to Japanese Patent Application Publication No. 2016-062644, the output characteristic and cycle characteristic of a nonaqueous electrolyte secondary battery are improved, when a positive electrode active material with a high potential is used while lithium phosphate is contained in a positive electrode active material layer.

### SUMMARY

However, as a result of the present inventors' earnest examinations about the conventional art, it has been found that a high-temperature storage characteristic of the nonaqueous electrolyte secondary battery has room for improvement; specifically, suppression of resistance increase when the nonaqueous electrolyte secondary battery is placed under high temperature for a long time has room for improvement.

In view of this, it is an object of the present disclosure to provide a method that can manufacture a nonaqueous electrolyte secondary battery in which resistance increase during the placement under high temperature for a long time is suppressed.

A method for manufacturing a nonaqueous electrolyte secondary battery disclosed herein includes the steps of: preparing a battery assembly including a positive electrode, a negative electrode, and a nonaqueous electrolyte; performing initial charging on the battery assembly; and performing an aging process on the battery assembly having been subjected to the initial charging. The positive electrode includes a positive electrode current collector and a positive electrode active material layer supported by the positive electrode current collector. The positive electrode active material layer contains a positive electrode active material and a thiophosphoric acid salt. A content of the thiophosphoric acid salt in the positive electrode active material layer is 1 mass % to 10 mass %. The initial charging is performed up to a voltage more than or equal to a decomposition start potential of the thiophosphoric acid salt. The aging process is performed in a state where the battery assembly is charged to the voltage more than or equal to the decomposition start potential of the thiophosphoric acid salt.

Such a constitution can provide the method that can manufacture the nonaqueous electrolyte secondary battery in which the resistance increase during the placement under high temperature for a long time is suppressed.

### BRIEF DESCRIPTION OF THE DRAWINGS

FIG. 1 is a flowchart expressing each step of a manufacturing method for a nonaqueous electrolyte secondary battery according to one embodiment of the present disclosure;

FIG. 2 is a schematic view for describing a structure of a wound electrode body of the nonaqueous electrolyte secondary battery manufactured according to one embodiment of the present disclosure; and

FIG. 3 is a cross-sectional view schematically illustrating a structure of the nonaqueous electrolyte secondary battery manufactured according to one embodiment of the present disclosure.

### DETAILED DESCRIPTION OF THE PREFERRED EMBODIMENTS

Embodiments of the present disclosure will hereinafter be described with reference to the drawings. Matters that are not mentioned in the present specification and that are necessary for the implementation of the present disclosure can be grasped as design matters of those skilled in the art based on the prior art in the relevant field. The present disclosure can be implemented on the basis of the contents disclosed in the present specification and common technical knowledge in the relevant field. It should be noted that in the drawings below, the members and parts with the same operation are explained by being denoted by the same reference sign. In addition, the size relation (length, width, thickness, etc.) in each drawing does not necessarily reflect the actual size relation. Moreover, in the present specification, the numerical range expressed as “A to B” includes A and B.

It should be noted that a “secondary battery” herein refers to an electricity storage device capable of being repeatedly charged and discharged. A “lithium ion secondary battery” herein refers to a secondary battery that uses lithium ions as charge carriers and performs charge and discharge by movement of charges accompanying lithium ions between positive and negative electrodes.

The present disclosure will hereinafter be described specifically in detail as an example regarding an embodiment in a case where the nonaqueous electrolyte secondary battery is a lithium ion secondary battery with a flat rectangular shape; however, it is not intended to limit the present disclosure to the embodiment below.

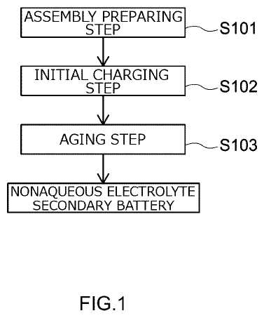

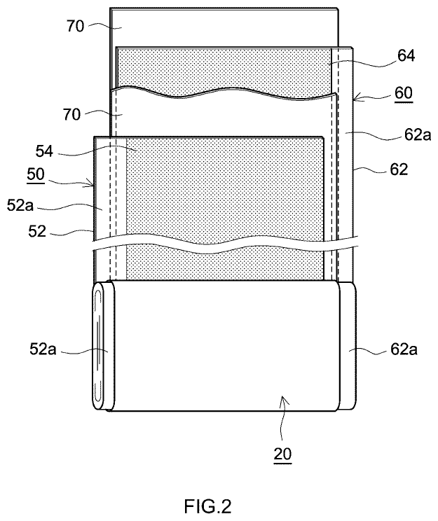

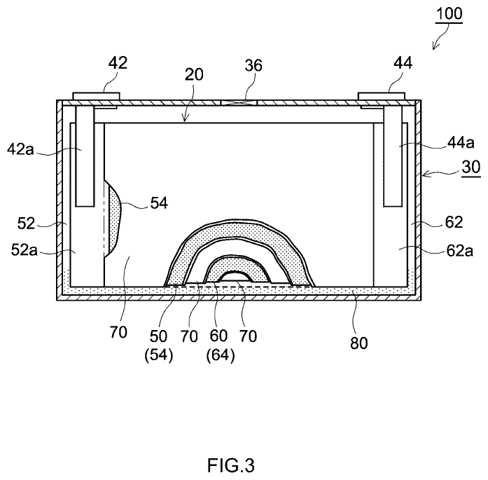

FIG. 1 illustrates each step of a manufacturing method for the nonaqueous electrolyte secondary battery according to this embodiment. FIG. 2 schematically illustrates a structure of an electrode body of the lithium ion secondary battery corresponding to one example of the nonaqueous electrolyte secondary battery to be obtained by the manufacturing method according to this embodiment. FIG. 3 schematically illustrates an internal structure of the lithium ion secondary battery corresponding to one example of the nonaqueous electrolyte secondary battery to be obtained by the manufacturing method according to this embodiment.

The manufacturing method for the nonaqueous electrolyte secondary battery according to this embodiment includes, as illustrated in FIG. 1, a step S101 of preparing a battery assembly including a positive electrode, a negative electrode, and a nonaqueous electrolyte (hereinafter also referred to as “assembly preparing step”), a step S102 of performing initial charging on the battery assembly (hereinafter also referred to as “initial charging step”), and a step S103 of performing an aging process on the battery assembly having been subjected to the initial charging (hereinafter referred to as “aging step”). The positive electrode includes a positive electrode current collector and a positive electrode active material layer supported by the positive electrode current collector. The positive electrode active material layer contains a positive electrode active material and a thiophosphoric acid salt. A content of the thiophosphoric acid salt in the positive electrode active material layer is 1 mass % to 10 mass %. The initial charging is performed up to voltage more than or equal to a decomposition start potential of the thiophosphoric acid salt. The aging process is performed in a state where the battery assembly is charged to the voltage more than or equal to the decomposition start potential of the thiophosphoric acid salt. Each step of the manufacturing method for the nonaqueous electrolyte secondary battery according to this embodiment will be described below.

First, the assembly preparing step S101 is described. In the assembly preparing step S101, the battery assembly including a positive electrode 50, a negative electrode 60, and a nonaqueous electrolyte 80 is prepared.

The positive electrode 50 used in the assembly preparing step S101 typically includes a positive electrode current collector 52 and a positive electrode active material layer 54 supported by the positive electrode current collector 52 as illustrated in FIG. 2, for example. The positive electrode active material layer 54 may be provided on either one surface or both surfaces of the positive electrode current collector 52, and is desirably provided on both surfaces. In the positive electrode 50, typically, a positive electrode active material layer non-formation part 52a (that is to say, a part where the positive electrode active material layer 54 is not formed and the positive electrode current collector 52 is exposed) is provided as illustrated in FIG. 2.

As the positive electrode current collector 52, a known positive electrode current collector used for a lithium ion secondary battery may be used and examples thereof include a sheet or a foil made of a metal with excellent electrical conductivity (for example, aluminum, nickel, titanium, stainless steel, or the like). The positive electrode current collector 52 is desirably an aluminum foil.

The size of the positive electrode current collector 52 is not limited in particular and may be determined as appropriate in accordance with the battery design. In the case of using the aluminum foil as the positive electrode current collector 52, the thickness is not limited in particular and is, for example, 5 μm or more and 35 μm or less and desirably 7 μm or more and 20 μm or less.

The positive electrode active material layer 54 contains the positive electrode active material and the thiophosphoric acid salt. The positive electrode active material may be a known positive electrode active material used for a lithium ion secondary battery. Specifically, for example, a lithium composite oxide, a lithium transition metal phosphate compound, or the like can be used as the positive electrode active material. A crystal structure of the positive electrode active material is not limited in particular and may be a layered structure, a spinel structure, an olivin structure, or the like.

As the lithium composite oxide, a lithium transition metal composite oxide containing at least one kind of Ni, Co, and Mn as the transition metal element is desirable. Specific examples thereof include a lithium-nickel composite oxide, a lithium-cobalt composite oxide, a lithium-manganese composite oxide, a lithium-nickel-manganese composite oxide, a lithium-nickel-cobalt-manganese composite oxide, a lithium-nickel-cobalt-aluminum composite oxide, a lithium-iron-nickel-manganese composite oxide, and the like.

It should be noted that, in the present specification, the term “lithium-nickel-cobalt-manganese composite oxide” encompasses oxides containing Li, Ni, Co, Mn, and O as constituent elements and moreover oxides containing one kind or two or more kinds of additive elements besides those above. Examples of such additive elements include transition metal elements, typical metal elements, and the like including Mg, Ca, Al, Ti, V, Cr, Y, Zr, Nb, Mo, Hf, Ta, W, Na, Fe, Zn, Sn, and the like. The additive element may be a metalloid element such as B, C, Si, or P or a non-metallic element such as S, F, Cl, Br, or I. This similarly applies to the lithium-nickel composite oxide, the lithium-cobalt composite oxide, the lithium-manganese composite oxide, the lithium-nickel-manganese composite oxide, the lithium-nickel-cobalt-aluminum composite oxide, the lithium-iron-nickel-manganese composite oxide, and the like described above.

Examples of the lithium transition metal phosphate compound include lithium iron phosphate (LiFePO₄), lithium manganese phosphate (LiMnPO₄), and lithium manganese iron phosphate, and the like.

Any of these positive electrode active materials may be used alone or two or more kinds may be used in combination.

The thiophosphoric acid salt is decomposed by the initial charging in the next initial charging step S102 and a film derived from the thiophosphoric acid salt is formed on a surface of the positive electrode active material. The initial charging is performed at the voltage more than or equal to the decomposition start potential of the thiophosphoric acid salt. However, it is only necessary to be able to apply the voltage, which is more than or equal to the decomposition start potential of the thiophosphoric acid salt, to the lithium ion secondary battery just at the initial charging; therefore, the upper-limit potential of the positive electrode active material in the general use mode of the lithium ion secondary battery may be lower than the decomposition start potential of the thiophosphoric acid salt.

From the viewpoints of the battery characteristic and the stability of the crystal structure at the initial charging, a lithium composite oxide with a layered structure is desired as the positive electrode active material. The lithium composite oxide desirably contains Ni. Therefore, as the positive electrode active material, the lithium-nickel-cobalt-manganese composite oxide and the lithium-nickel-cobalt-aluminum composite oxide are desirable, and the lithium-nickel-cobalt-manganese composite oxide is more desirable.

The ratio of Ni to the total metal elements other than Li in the lithium composite oxide is desirably 20 mol % to 60 mol % and more desirably 30 mol % to 50 mol %.

The average particle diameter (median diameter: D50) of the positive electrode active material is not limited in particular and is, for example, 0.05 μm or more and 25 μm or less, desirably 1 μm or more and 20 μm or less, and more desirably 3 μm or more and 15 μm or less. It should be noted that the average particle diameter (D50) of the positive electrode active material can be determined by, for example, a laser diffraction scattering method.

The content of the positive electrode active material in the positive electrode active material layer 54 (that is to say, the content of the positive electrode active material relative to the total mass of the positive electrode active material layer 54) is not limited in particular and is, for example, 80 mass % or more, desirably 85 mass % or more, and more desirably 87 mass % or more.

The thiophosphoric acid salt is a component (so-called positive electrode additive) that is added to the positive electrode in order to form the film on the surface of the positive electrode active material by the initial charging in the next initial charging step S102. The thiophosphoric acid salt is a salt of a cation and a thiophosphoric acid anion represented by Formula (1) below. The thiophosphoric acid salt is typically an inorganic salt and accordingly, typically does not include an organic group. The thiophosphoric acid anion is a trivalent anion and the cation is monovalent, divalent, or trivalent cation (particularly, metal cation).

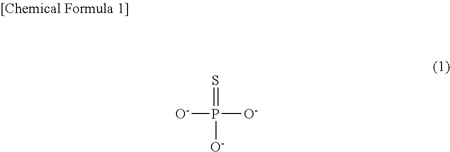

Since the thiophosphoric acid anion largely contributes to the film formation, the kind of cation is not limited in particular. Examples of the cation include alkali metal cations such as Li⁺, Na⁺, and K⁺, alkaline earth metal cations such as Mg²⁺, Ca2+, Sr²⁺, and Ba²⁺, Group-12 element cations such as Zn²⁺, Group-13 element cations such as Al³⁺, and the like. Among these, the alkali metal cation is desirable. Therefore, the alkali metal salt of the thiophosphoric acid is desirable as the thiophosphoric acid salt.

From the viewpoint of ease of availability, sodium thiophosphate is particularly desirable as the thiophosphoric acid salt. From the viewpoint of the battery performance, lithium thiophosphate is particularly desirable as the thiophosphoric acid salt.

When the content of the thiophosphoric acid salt in the positive electrode active material layer 54 is higher, the effect of suppressing the resistance increase while a lithium ion secondary battery 100 is placed under high temperature for a long time is higher. Therefore, the content of the thiophosphoric acid salt in the positive electrode active material layer 54 (that is to say, the mass ratio of the thiophosphoric acid salt relative to the total mass of the entire components of the positive electrode active material layer 54) is 1 mass % or more, desirably 2 mass % or more, more desirably 2.5 mass % or more, and still more desirably 3 mass % or more. On the other hand, if the content of the thiophosphoric acid salt is higher, the initial resistance tends to increase. In view of this, the content of the thiophosphoric acid salt in the positive electrode active material layer 54 is 10 mass % or less, desirably 8 mass % or less, more desirably 7.5 mass % or less, and still more desirably 7 mass % or less.

The positive electrode active material layer 54 may contain only the thiophosphoric acid salt as the positive electrode additive or may further contain another positive electrode additive within the range not interrupting the effect of the present disclosure remarkably.

The positive electrode active material layer 54 may contain a component other than the positive electrode active material and the thiophosphoric acid salt described above (that is, such a component is an optional component). Examples of such an optional component include a conductive material, a binder, and the like. As the conductive material, for example, a carbon material such as carbon black (for example, acetylene black), carbon nanotube (CNT), or graphite can be suitably used. As the binder, for example, polyvinylidene fluoride (PVDF) or the like can be used. In the case of using CNT as the conductive material, the positive electrode active material layer 54 may further contain a dispersant for CNT.

The content of the conductive material in the positive electrode active material layer 54 is not limited in particular and is desirably 0.1 mass % or more and 15 mass % or less, and more desirably 0.5 mass % or more and 13 mass % or less. The content of the binder in the positive electrode active material layer 54 is not limited in particular and is desirably 1 mass % or more and 15 mass % or less, and more desirably 1.5 mass % or more and 10 mass % or less.

The thickness of the positive electrode active material layer 54 is not limited in particular and is, for example, 10 μm or more and 300 μm or less and desirably 20 μm or more and 200 μm or less.

The positive electrode sheet 50 may include an insulating layer (not illustrated) at a border part between the positive electrode active material layer non-formation part 52a and the positive electrode active material layer 54. The insulating layer includes, for example, ceramic particles or the like.

The positive electrode 50 can be manufactured and prepared in accordance with a known method. For example, a positive electrode paste containing the positive electrode active material, the thiophosphoric acid salt, and the optional component is produced, the positive electrode paste is applied on the positive electrode current collector 52 and dried, and a pressing process is performed as necessary; thus, the positive electrode 50 can be prepared. It should be noted that the term “paste” in this specification is used as a term that encompasses modes called “slurry” and “ink”.

The negative electrode 60 used in the assembly preparing step S101 may be a known negative electrode used for a lithium ion secondary battery. The negative electrode 60 typically includes a negative electrode current collector 62 and a negative electrode active material layer 64 supported by the negative electrode current collector 62 as illustrated in FIG. 2, for example. The negative electrode active material layer 64 may be provided on either one surface or both surfaces of the negative electrode current collector 62, and is desirably provided on both surfaces. In the negative electrode 60, typically, a negative electrode active material layer non-formation part 62a (that is to say, a part where the negative electrode active material layer 64 is not formed and the negative electrode current collector 62 is exposed) is provided as illustrated in FIG. 2.

As the negative electrode current collector 62, a known negative electrode current collector used for a lithium ion secondary battery may be used and examples thereof include a sheet or a foil made of a metal with excellent electrical conductivity (for example, copper, nickel, titanium, stainless steel, or the like). The negative electrode current collector 62 is desirably a copper foil.

The size of the negative electrode current collector 62 is not limited in particular and may be determined as appropriate in accordance with the battery design. In the case of using the copper foil as the negative electrode current collector 62, the thickness is not limited in particular and is, for example, 5 μm or more and 35 μm or less and desirably 7 μm or more and 20 μm or less.

The negative electrode active material layer 64 contains a negative electrode active material. As the negative electrode active material, for example, a carbon material such as graphite, hard carbon, or soft carbon can be used. Graphite may be either natural graphite or artificial graphite, and may be amorphous carbon coated graphite in which graphite is coated with an amorphous carbon material.

The average particle diameter (median diameter: D50) of the negative electrode active material is not limited in particular and is, for example, 0.1 μm or more and 50 μm or less, desirably 1 μm or more and 25 μm or less, and more desirably 5 μm or more and 20 m or less. It should be noted that the average particle diameter (D50) of the negative electrode active material can be determined by, for example, a laser diffraction scattering method.

The negative electrode active material layer 64 can contain a component other than the active material, for example a binder, a thickener, or the like. Examples of the binder include styrene butadiene rubber (SBR), polyvinylidene fluoride (PVDF), and the like. Examples of the thickener include carboxymethyl cellulose (CMC) and the like.

The content of the negative electrode active material in the negative electrode active material layer 64 is desirably 90 mass % or more and more desirably 95 mass % or more and 99 mass % or less. The content of the binder in the negative electrode active material layer 64 is desirably 0.1 mass % or more and 8 mass % or less, and more desirably 0.5 mass % or more and 3 mass % or less. The content of the thickener in the negative electrode active material layer 64 is desirably 0.3 mass % or more and 3 mass % or less, and more desirably 0.5 mass % or more and 2 mass % or less.

The thickness of the negative electrode active material layer 64 is not limited in particular and is, for example, 10 μm or more and 300 μm or less and desirably 20 μm or more and 200 μm or less.

The negative electrode 60 can be manufactured and prepared in accordance with a known method. For example, a negative electrode paste containing the negative electrode active material and the optional component is produced, the negative electrode paste is applied on the negative electrode current collector 62 and dried, and a pressing process is performed as necessary; thus, the negative electrode 60 can be prepared.

The positive electrode 50 and the negative electrode 60 are typically used as an electrode body 20 in which the positive electrode 50 and the negative electrode 60 are stacked through a separator 70. The electrode body 20 may be either a stacked-type electrode body or a wound electrode body. In the illustrated example, the electrode body 20 is a wound electrode body.

Examples of the separator 70 include a porous sheet (film) formed of resin such as polyethylene (PE), polypropylene (PP), polyester, cellulose, or polyamide. Such a porous sheet may have a single-layer structure or a multilayer structure of two or more layers (for example, three-layer structure in which a PP layer is stacked on each surface of a PE layer). The separator 70 may have a heat-resistant layer (HRL) on a surface thereof.

The thickness of the separator 70 is not limited in particular and is, for example, 5 m or more and 50 μm or less and desirably 10 μm or more and 30 μm or less. The air permeability of the separator 70 obtained by a Gurley test method is not limited in particular and is desirably 350 seconds/100 cc or less.

The electrode body 20 can be manufactured in accordance with a known method. In the case where the electrode body 20 is the wound electrode body as shown by the illustrated example, for example, the electrode body 20 can be prepared as follows.

First, the positive electrode sheet 50 and the negative electrode sheet 60 are overlapped on each other so that the separator sheet 70 is held between the positive electrode sheet 50 and the negative electrode sheet 60. Another separator sheet 70 is stacked thereon. In this case, as illustrated in FIG. 2, the positive electrode sheet 50 and the negative electrode sheet 60 are overlapped on each other so that the positive electrode active material layer non-formation part 52a of the positive electrode sheet 50 and the negative electrode active material layer non-formation part 62a of the negative electrode sheet 60 protrude in opposite directions from end parts of the two separator sheets 70 in a width direction thereof.

The obtained laminated body is wound. The laminated body can be wound in accordance with a known method. For example, the winding can be performed, using a winding machine including a known winding core, by winding the laminated body around an outer peripheral surface of the winding core. The winding condition may be similar to a known condition.

Subsequently, the wound electrode body with a flat shape is manufactured by pressing the wound laminated body. This pressing can be performed by pressing the laminated body wound in the winding step, using a known pressing device that has been used in manufacturing general wound electrode bodies with a flat shape. The pressing condition may be similar to a known condition.

On the other hand, a battery case 30 is prepared. Specifically, as illustrated in FIG. 3, a main body of the battery case 30 with an opening part, and a lid body of the battery case 30 are prepared. The opening part has a size that enables the insertion of the wound electrode body 20. The lid body has a size that closes the opening part of the main body of the battery case 30. In addition, the lid body includes a thin safe valve 36 that is set to, when the internal pressure of the battery case 30 has risen to or above a predetermined level, release the internal pressure, and an injection port (not illustrated) for injecting the nonaqueous electrolyte. The battery case 30 is formed of, for example, a metal material with small weight and excellent thermal conductivity, such as aluminum.

Moreover, the nonaqueous electrolyte 80 is prepared. The nonaqueous electrolyte 80 typically contains a nonaqueous solvent and a supporting salt (electrolyte salt). As the nonaqueous solvent, various organic solvents used for the electrolyte solution of the general lithium ion secondary batteries, such as carbonates, ethers, esters, nitriles, sulfones, and lactones, can be used without particular limitations. In particular, the carbonates and the esters are desirable and specific examples thereof include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluorodimethyl carbonate (TFDMC), methyl acetate, methyl propionate, and the like. As the nonaqueous solvent described above, one kind can be used alone or two or more kinds thereof can be used in combination as appropriate.

Desired examples of the supporting salt include lithium salts such as LiPF₆, LiBF₄, and lithium bis(fluorosulfonyl)imide (LiFSI) (desirably, LiPF₆). The concentration of the supporting salt is desirably 0.7 mol/L or more and 1.3 mol/L or less.

The nonaqueous electrolyte 80 may contain a component other than the aforementioned components (for example, various additives) unless the effect of the present disclosure is not impaired remarkably.

For example, in the case where the nonaqueous electrolyte 80 contains an oxalato complex as a film formation agent, the resistance increase during the placement under high temperature for a long time can be suppressed more. Examples of the oxalato complex include lithium difluoro(oxalato)borate (LiBF₂(C₂O₄)), lithium bis(oxalato)borate (LiB(C₂O₄)₂), lithium tetrafluoro(oxalato)phosphate (LiPF₄(C₂O₄)), lithium difluorobis(oxalato)phosphate (LiPF₂(C₂O₄)₂), and the like. In particular, lithium bis(oxalato)borate (LiBOB) is desirable because of having the high film formation capability.

The concentration of the oxalato complex in the nonaqueous electrolyte 80 is, for example, 0.1 mass % or more and 1.5 mass % or less, desirably 0.3 mass % or more and 1.5 mass % or less, and more desirably 0.5 mass % or more and 1.5 mass % or less. From the viewpoint of achieving both the initial resistance and the high-temperature storage characteristic, the concentration of the oxalato complex in the nonaqueous electrolyte 80 is particularly desirably 0.5 mass % or more and 1.0 mass % or less.

Examples of the other additive include a film formation agent such as vinylene carbonate (VC), a gas generator such as biphenyl (BP) or cyclohexyl benzene (CHB), a thickener, and the like.

Next, a positive electrode terminal 42 and a positive electrode current collecting plate 42a, and a negative electrode terminal 44 and a negative electrode current collecting plate 44a are attached to the lid body of the battery case 30. The positive electrode current collecting plate 42a and the negative electrode current collecting plate 44a are welded to the positive electrode active material layer non-formation part 52a and the negative electrode active material layer non-formation part 62a that are exposed at end parts of the wound electrode body 20, respectively, through ultrasonic welding, resistance welding, or the like. Then, the wound electrode body 20 is accommodated inside through the opening part of the main body of the battery case 30, and the main body and the lid body of the battery case 30 are welded together through laser welding or the like.

Subsequently, the nonaqueous electrolyte 80 is injected through the injection port of the lid body of the battery case 30. The nonaqueous electrolyte 80 can be injected in accordance with a known method. After the nonaqueous electrolyte 80 is injected, the injection port is sealed; thus, the battery assembly 100 can be obtained. The injection port can be sealed in accordance with a known method.

Next, the initial charging step S102 is described. In the initial charging step S102, the battery assembly 100 is subjected to initial charging. This initial charging is performed up to the voltage more than or equal to the decomposition start potential of the thiophosphoric acid salt. Thus, the thiophosphoric acid salt in the positive electrode active material layer 54 can be decomposed and the film derived from the thiophosphoric acid salt can be formed on the surface of the positive electrode active material.

Here, the decomposition start potential of the thiophosphoric acid salt is relatively low as the positive electrode additive. For example, while the decomposition start potential of Li₃PO₃ is 4.50 V (vs Li⁺/Li) (that is, 4.50 V based on metal lithium), the decomposition start potential of sodium thiophosphate (Na₃PSO₃) is 4.35 V (vs Li⁺/Li). Therefore, when the battery assembly 100 is subjected to the initial charging, the thiophosphoric acid salt can be decomposed efficiently and the film with high quality can be formed on the surface of the positive electrode active material layer. As a result, the resistance increase when the lithium ion secondary battery 100 is placed under high temperature for a long time can be suppressed.

The upper-limit voltage of the initial charging depends on the kind of thiophosphoric acid salt. If the upper-limit voltage of the initial charging is too high, however, the nonaqueous electrolyte 80 may be decomposed excessively or the structure of the positive electrode active material may deteriorate, for example. Accordingly, the upper-limit voltage of the initial charging is desirably the voltage at which the positive electrode potential is 4.70 V (vs Li⁺/Li), and more desirably the voltage at which the positive electrode potential is 4.50 V (vs Li⁺/Li).

The initial charging is performed up to the voltage at which the potential of the positive electrode 50 is desirably 4.35 V (vs Li⁺/Li) to 4.70 V (vs Li⁺/Li) and more desirably 4.35 V (vs Li⁺/Li) to 4.50 V (vs Li⁺/Li).

The initial charging can be performed in accordance with a known method. Specifically, the initial charging can be performed by applying a predetermined voltage between the positive electrode 50 and the negative electrode 60 using a known voltage application device (not illustrated). The current value is not limited in particular and is desirably 1 C or less and more desirably 0.1 C or more and 0.5 C or less. It should be noted that the charging is normally followed by discharging. In the initial charging, the charging may be performed only once or a plurality of times (for example, twice or three times).

Next, the aging step S103 is described. In the aging step S103, the battery assembly 100 that has been initially charged in the previous step is subjected to the aging process. This aging process is performed in a state where the battery assembly 100 is charged to the voltage more than or equal to the decomposition start potential of the thiophosphoric acid salt. According to this, the thiophosphoric acid salt in the positive electrode active material layer 54 can be decomposed further and the film derived from the thiophosphoric acid salt can be formed additionally on the surface of the positive electrode active material; consequently, the quality of the film can be increased further.

If the voltage of the battery assembly 100 in the aging step S103 is too high, the nonaqueous electrolyte 80 may be decomposed excessively or the structure of the positive electrode active material may deteriorate, for example. Accordingly, the voltage of the battery assembly 100 is desirably less than or equal to the voltage at which the positive electrode potential is 4.70 V (vs Li⁺/Li), and more desirably less than or equal to the voltage at which the positive electrode potential is 4.50 V (vs Li⁺/Li).

Therefore, the aging process is performed in the state of being charged to the voltage at which the potential of the positive electrode 50 is desirably 4.35 V (vs Li⁺/Li) to 4.70 V, and more desirably 4.35 V to 4.50 V (vs Li⁺/Li).

The temperature of the aging process is not limited in particular and is desirably the temperature higher than room temperature. Specifically, the temperature of the aging process is desirably 40° C. to 100° C. and more desirably 40° C. to 75° C. The time of the aging process is not limited in particular. The time of the aging process is desirably 1 hour to 72 hours and more desirably 4 hours to 24 hours.

Thus, it is particularly desirable that the aging process be performed in the temperature range of 40° C. to 75° C. for 4 hours to 24 hours.

The aging step S103 can be performed in accordance with a known method. Specifically, for example, the aging step S103 can be performed in such a way that the charged state of the battery assembly 100 adjusted using a known voltage application device (not illustrated), and the battery assembly 100 is left to stand in a thermostatic chamber or the like.

Even in the aging step S103, the thiophosphoric acid salt is decomposed and the film derived from the thiophosphoric acid salt is formed on the surface of the positive electrode active material. Therefore, by performing the initial charging step S102 and the aging step S103, the thiophosphoric acid salt can be decomposed efficiently and the film can be effectively formed on the surface of the positive electrode active material.

Through the aforementioned steps, the lithium ion secondary battery 100 can be obtained. In the lithium ion secondary battery 100, the film with the high quality derived from the thiophosphoric acid salt is formed on the surface of the positive electrode active material and by this film, the decomposition of the nonaqueous electrolyte 80 during storage can be suppressed. As a result, in the lithium ion secondary battery 100, the resistance increase during the placement under high temperature for a long time is suppressed. Therefore, by the manufacturing method according to this embodiment, the lithium ion secondary battery 100 with excellent durability can be manufactured.

The lithium ion secondary battery 100 can be used in various applications. Specific applications include a portable power source for a personal computer, a mobile electronic appliance, a mobile terminal, or the like, a power source for driving a vehicle such as a battery electric vehicle (BEV), a hybrid electric vehicle (HEV), or a plug-in hybrid electric vehicle (PHEV), a storage battery of a small electrical energy storage device, and the like, and in particular, the power source for driving a vehicle is desirable. The lithium ion secondary battery 100 can also be used in a mode of a battery pack in which a plurality of lithium ion secondary batteries 100 are connected to each other in series and/or in parallel typically.

The lithium ion secondary battery 100 with a rectangular shape including the wound electrode body 20 with a flat shape is described as one example. However, by the manufacturing method for the nonaqueous electrolyte secondary battery disclosed herein, a lithium ion secondary battery including a stacked-type electrode body (that is, an electrode body in which a plurality of positive electrodes and a plurality of negative electrodes are stacked alternately) can also be manufactured. In addition, by the manufacturing method for the nonaqueous electrolyte secondary battery disclosed herein, a coin type lithium ion secondary battery, a button type lithium ion secondary battery, a cylindrical lithium ion secondary battery, or a laminate case type lithium ion secondary battery can also be manufactured. Furthermore, by the manufacturing method for the nonaqueous electrolyte secondary battery disclosed herein, a nonaqueous electrolyte secondary battery other than the lithium ion secondary battery can also be manufactured.

Although Examples of the present disclosure will be described below, it is not intended to limit the present disclosure to Examples below.

### Examples 1 to 6 and Comparative Examples 1 to 6

### [Manufacture of Lithium Ion Secondary Battery Assembly]

LiNi_{0.5}Co_{0.2}Mn_{0.3}O₂(NCM) as positive electrode active material powder, acetylene black (AB) as the conductive material, and polyvinylidene fluoride (PVdF) as the binder were mixed at a mass ratio of NCM:AB:PVdF=90:5:5. To this mixture, the positive electrode additive shown in Table 1 was added so that the content thereof in the positive electrode active material layer satisfied the amount shown in Table 1, and mixed with N-methylpyrrolidone (NMP). Thus, a slurry for forming a positive electrode active material layer was prepared. This slurry was applied on both surfaces of an aluminum foil and then dried; thus, the positive electrode active material layer was formed. The total of weight per unit area on both surfaces at this time was 15 mg/cm². Next, the positive electrode active material layer was subjected to a roll pressing process so that the density thereof became 2.5 g/cm³; thus, the positive electrode sheet was obtained.

Natural graphite (C) as the negative electrode active material, styrene butadiene rubber (SBR) as the binder, and carboxymethyl cellulose (CMC) as the thickener were mixed at a mass ratio of C:SBR:CMC=97:2:1 with ion exchanged water, and thus a slurry for forming a negative electrode active material layer was prepared. This slurry was applied on both surfaces of a copper foil and then dried; thus, the negative electrode active material layer was formed. The total of weight per unit area on both surfaces at this time was 9 mg/cm². Next, the negative electrode active material layer was subjected to a roll pressing process so that the density thereof became 1.2 g/cm³; thus, the negative electrode sheet was obtained.

Moreover, a polyolefin porous film was prepared as the separator. The positive electrode sheet and the negative electrode sheet that were manufactured were stacked through the separator; thus, the stacked-type electrode body was manufactured. The terminals and the like were attached to this electrode body and the obtained electrode body was accommodated in the battery case made of aluminum.

A mixed solvent containing ethylene carbonate (EC), dimethyl carbonate (DMC), and ethyl methyl carbonate (EMC) at a volume ratio of 25:40:35 was prepared. In Examples 1 and 2 and Comparative Examples 1 to 6, LiPF₆ was dissolved at a concentration of 1.1 mol/L in this mixed solvent; thus, the nonaqueous electrolyte solution was prepared. In Examples 3 to 6, LiPF₆ was dissolved at a concentration of 1.1 mol/L in this mixed solvent and moreover, lithium bis(oxalato)borate (LiBOB) was dissolved at an addition amount shown in Table 1; thus, the nonaqueous electrolyte solution was prepared. After the prepared nonaqueous electrolyte solution was injected into the battery case, the battery case was sealed and the battery assembly was obtained.

### [Initial Charging]

The obtained battery assembly was placed in a thermostatic chamber of 25° C. After the battery assembly was charged with a constant current at a current value of 0.1 C up to a predetermined upper-limit voltage, the battery assembly was discharged with a constant current to 3.0 V. This predetermined upper-limit voltage was the voltage corresponding to the positive electrode potential (vs Li⁺/Li) shown in Table 1. As the initial charging, this charging and discharging was performed twice.

### [Aging Process]

The battery assembly after the initial charging was adjusted to have the voltage corresponding to the positive electrode potential (vs Li⁺/Li) shown in Table 1. After that, the battery assembly was placed in the thermostatic chamber of 60° C. and subjected to the aging process for 12 hours. Thus, the lithium ion secondary battery was obtained.

### [Evaluation on Initial Characteristic]

After the lithium ion secondary battery manufactured in each of Examples and Comparative Examples was charged with a constant current at a current value of 0.1 C up to the same upper-limit voltage as that in the initial charging, the lithium ion secondary battery was discharged with a constant current to 3.0 V. The discharge capacity at this time was measured and used as the initial capacity.

Assuming that this initial capacity be an SOC of 100%, the lithium ion secondary battery was adjusted to have an SOC of 50% at 25° C. After that, the lithium ion secondary battery was placed in the thermostatic chamber of −10° C. and discharged at a current value of 10 C for 10 seconds. The voltage change quantity ΔV at this time was measured and by using this voltage change quantity ΔV and the current value, the output resistance of the lithium ion secondary battery was calculated as the initial resistance. The results are shown in Table 1.

### [Evaluation on High-Temperature Storage Characteristic]

The lithium ion secondary battery was adjusted to have an SOC of 80% in a 25° C.-temperature environment. This lithium ion secondary battery was placed in the thermostatic chamber of 60° C. and stored for 60 days. After that, the output resistance after the storage was measured by the same method as that for the initial resistance. The resistance increase rate (%) was obtained by an expression: (output resistance after high-temperature storage/initial resistance)×100. The results are shown in Table 1.

### [Table 1]

TABLE 1

| | | | | Positive | | | |
|---|---|---|---|---|---|---|---|
| | | | | electrode | | | |
| | Positive electrode additive | | Addition | potential of | | Battery performance | |
| | | Addition | amount of | upper-limit | Positive electrode | Initial | Resistance |
| | | amount | LiBOB | voltage | potential in aging | resistance | increase |
| | Kind | (mass %) | (mass %) | (V vs Li⁺/Li) | step (V vs Li⁺/Li) | (mΩ) | after strage (%) |
| Example 1 | Na₃PSO₃ | 3 | 0 | 4.35 | 4.35 | 11.1 | 106 |
| Example 2 | Na₃PSO₃ | 7 | 0 | 4.35 | 4.35 | 11.4 | 104 |
| Example 3 | Na₃PSO₃ | 3 | 0.5 | 4.35 | 4.35 | 12.5 | 102 |
| Example 4 | Na₃PSO₃ | 7 | 0.5 | 4.35 | 4.35 | 12.8 | 102 |
| Example 5 | Na₃PSO₃ | 7 | 1.0 | 4.35 | 4.35 | 12.9 | 102 |
| Example 6 | Na₃PSO₃ | 7 | 1.5 | 4.35 | 4.35 | 13.2 | 101 |
| Comparative | Na₃PSO₃ | 3 | 0 | 4.35 | 3.7 | 10.9 | 109 |
| Example 1 | | | | | | | |
| Comparative | Na₃PSO₃ | 3 | 0 | 4.35 | 4.2 | 10.9 | 108 |
| Example 2 | | | | | | | |
| Comparative | Na₃PSO₃ | 3 | 0 | 4.2 | 3.7 | 9.7 | 125 |
| Example 3 | | | | | | | |
| Comparative | None | 0 | 0 | 4.35 | 3.7 | 9.4 | 129 |
| Example 4 | | | | | | | |
| Comparative | Li₃PO₄ | 3 | 0 | 4.35 | 3.7 | 10.2 | 123 |
| Example 5 | | | | | | | |
| Comparative | Trimehyl thiophosphate | 3 | 0 | 4.35 | 3.7 | 10.7 | 121 |
| Example 6 | | | | | | | |

The decomposition start potential of sodium thiophosphate (Na₃PSO₃) is 4.35 V (vs Li⁺/Li). In Comparative Example 1 and Comparative Example 2, the voltage in the aging step is low and in the aging step, coating derived from the thiophosphoric acid is not formed. In Comparative Example 3, the voltage in the initial charging step and the aging step is low and in the initial charging step and the aging step, the coating derived from the thiophosphoric acid is not formed. The comparison of Comparative Example 1 and Comparative Example 2 with Comparative Example 3 indicates that the resistance increase during the high-temperature storage can be suppressed by forming the film in such a way that the battery assembly is subjected to the initial charging up to the voltage more than or equal to the decomposition start potential of Na₃PSO₃. In addition, the comparison of Examples 1 and 2 with Comparative Examples 1 and 2 indicates that the resistance increase during the high-temperature storage can be suppressed further by forming the film additionally in such a way that the aging process is performed with the battery assembly charged up to the voltage more than or equal to the decomposition start potential of Na₃PSO₃.

In Comparative Example 4, the positive electrode additive is not used and in Comparative Examples 5 and 6, trilithium phosphate and thiophosphoric acid ester are used as the positive electrode additive, respectively. The comparison of Examples 1 and 2 with Comparative Examples 4 to 6 indicates that the effect of suppressing the resistance increase during the high-temperature storage can be obtained when the thiophosphoric acid salt is used as the positive electrode additive.

In Examples 3 to 6, LiBOB is contained in the nonaqueous electrolyte solution. These results indicate that the higher effect of suppressing the resistance increase during the high-temperature storage can be obtained when LiBOB is contained in the nonaqueous electrolyte solution.

Accordingly, it can be understood that by the manufacturing method for the nonaqueous electrolyte secondary battery disclosed herein, the nonaqueous electrolyte secondary battery in which the resistance increase during the placement under the high temperature for a long time is suppressed can be manufactured.

The specific examples of the present disclosure have been described above in detail; however, these are examples and will not limit the scope of claims. The techniques described in the scope of claims include those in which the specific examples exemplified above are variously modified and changed.

That is to say, the following items [1] to [7] are given as the manufacturing method for the nonaqueous electrolyte secondary battery, disclosed herein.

[1] A method for manufacturing the nonaqueous electrolyte secondary battery, including the steps of: preparing the battery assembly including the positive electrode, the negative electrode, and the nonaqueous electrolyte; performing the initial charging on the battery assembly; and performing the aging process on the battery assembly having been subjected to the initial charging, in which the positive electrode includes the positive electrode current collector and the positive electrode active material layer supported by the positive electrode current collector, the positive electrode active material layer contains the positive electrode active material and the thiophosphoric acid salt, the content of the thiophosphoric acid salt in the positive electrode active material layer is 1 mass % to 10 mass %, the initial charging is performed up to the voltage more than or equal to the decomposition start potential of the thiophosphoric acid salt, and the aging process is performed in the state where the battery assembly is charged to the voltage more than or equal to the decomposition start potential of the thiophosphoric acid salt.
[2] The method according to Item [1], in which the content of the thiophosphoric acid salt in the positive electrode active material layer is 3 mass % to 7 mass %.
[3] The method according to Item [1] or [2], in which the initial charging is performed up to the voltage at which the potential of the positive electrode is 4.35 V (vs Li⁺/Li) to 4.50 V (vs Li⁺/Li), and the aging process is performed in the state where the battery assembly is charged to the voltage at which the potential of the positive electrode is 4.35 V (vs Li⁺/Li) to 4.50 V (vs Li⁺/Li).
[4] The method according to any one of Items [1] to [3], in which the aging process is performed in the temperature range of 40° C. to 75° C. for 4 hours to 24 hours.
[5] The method according to any one of Items [1] to [4], in which the thiophosphoric acid salt is the alkali metal salt of the thiophosphoric acid.
[6] The method according to any one of Items [1] to [5], in which the positive electrode active material is at least one kind of composite oxide selected from the group consisting of the lithium-nickel-cobalt-manganese composite oxide and the lithium-nickel-cobalt-aluminum composite oxide.
[7] The method according to any one of Items [1] to [6], in which the nonaqueous electrolyte contains lithium bis(oxalato)borate.

What is claimed is:

1. A method for manufacturing a nonaqueous electrolyte secondary battery, comprising the steps of:
preparing a battery assembly including a positive electrode, a negative electrode, and a nonaqueous electrolyte;
performing initial charging on the battery assembly; and
performing an aging process on the battery assembly having been subjected to the initial charging, wherein
the positive electrode includes a positive electrode current collector and a positive electrode active material layer supported by the positive electrode current collector,
the positive electrode active material layer contains a positive electrode active material and a thiophosphoric acid salt,
a content of the thiophosphoric acid salt in the positive electrode active material layer is 1 mass % to 10 mass %,
the initial charging is performed up to a voltage more than or equal to a decomposition start potential of the thiophosphoric acid salt, and
the aging process is performed in a state where the battery assembly is charged to the voltage more than or equal to the decomposition start potential of the thiophosphoric acid salt.

2. The method according to claim 1, wherein the content of the thiophosphoric acid salt in the positive electrode active material layer is 3 mass % to 7 mass %.

3. The method according to claim 1, wherein
the initial charging is performed up to a voltage at which a potential of the positive electrode is 4.35 V (vs Li⁺/Li) to 4.50 V (vs Li⁺/Li), and
the aging process is performed in a state where the battery assembly is charged to the voltage at which the potential of the positive electrode is 4.35 V (vs Li⁺/Li) to 4.50 V (vs Li⁺/Li).

4. The method according to claim 1, wherein the aging process is performed in a temperature range of 40° C. to 75° C. for 4 hours to 24 hours.

5. The method according to claim 1, wherein the thiophosphoric acid salt is an alkali metal salt of a thiophosphoric acid.

6. The method according to claim 1, wherein the positive electrode active material is at least one kind of composite oxide selected from the group consisting of a lithium-nickel-cobalt-manganese composite oxide and a lithium-nickel-cobalt-aluminum composite oxide.

7. The method according to claim 1, wherein the nonaqueous electrolyte contains lithium bis(oxalato)borate.
